(19) United States
(12) Patent Application Publication
(10) Pub. No.: US 2006/0035636 A1
(43) Pub. Date: Feb. 16, 2006

(54) Access point service for mobile users

(76) Inventor: Hannu Pirila, Littoinen (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/956,338

(22) Filed: Oct. 4, 2004

(30) Foreign Application Priority Data
Aug. 11, 2004 (FI) 20045288

(51) Int. Cl. H04B 7/00; H04Q 7/20

(52) U.S. Cl. 455/435.2; 455/435.1

(57) ABSTRACT

The invention relates to the provision of complementary access point service for users of a cellular mobile communication network (PLMN). In order to allow a mobile user to find an available complementary access point (AP), such as a WLAN access point, access point information is maintained of such cells (C1, C2, C3) and their signal attributes that would be measured by the user terminal (MS), if it were in the coverage area of a certain complementary access point (AP) or close to it. As the user terminal (MS) receives signals in the mobile network (PLMN) it compares the signals with the maintained access point information. If the received signals correspond to the maintained information, it can be concluded that a complementary access point (AP) is available at that area and the user terminal (MS) may initiate the search for the complementary access point (AP).

### FIELD OF THE INVENTION

The invention relates to the provision of services for users of a mobile communication network, who are also able to use another access network, such as a WLAN (Wireless Local Area Network) access network that is complementary to the mobile communication network.

### BACKGROUND OF THE INVENTION

The current development towards truly mobile computing and networking has brought on the evolvement of various access technologies that provide the users with access to the Internet, real-time and other telecommunications services also when they are outside their home network. At present, wireless Internet access is typically based on either wireless LAN technology or mobile networks, or both.

In wireless LAN technology, user terminals are provided with wireless LAN connections, whereby they can access, for instance, the Internet through wireless LAN access points, which are mainly located in various hot spots, such as airports, convention centers, railway stations, or shopping malls.

An example of the new mobile network technologies enabling Internet access is GPRS (General Packet Radio Service). GPRS aims at providing high-quality services for present GSM subscribers by efficiently utilizing the current network infrastructure and protocols. GPRS has evolved from GSM with the introduction of two new network elements: SGSN (Serving GPRS Support Node) and GGSN (Gateway GPRS Support Node). These elements will also provide packet-based services in the upcoming UMTS (Universal Mobile Telecommunication System) networks.

What is known as multimode radio technology is also becoming more and more common in user devices. Having his or her mobile terminal equipped with a multimode radio technology, the user can choose the most suitable network type in each case, i.e. the user can choose whether the services are accessed through GPRS or WLAN, for example. For instance, the user may sometimes prefer the higher data rate offered by the WLAN networks.

A drawback relating to the selection of the network through which the services are accessed is that the user cannot always be aware of where WLAN services are available. It is not feasible to perform the search for the WLAN access network continuously, due to a too high current consumption of the user terminal during the search. On the other hand, performing the search every 15 minutes, for example, may not be enough in the user's point of view.

### BRIEF DESCRIPTION OF THE INVENTION

An object of the present invention is thus to provide a method and an arrangement for implementing the method so as to overcome the above problem. The objects of the invention are achieved by a method, a system, a network, a user terminal and a software product, which are characterized by what is stated in the independent claims. The embodiments of the invention are disclosed in the dependent claims.

The invention is based on the idea of providing access point information on access points, selected from access networks complementary to a cellular communications network, and on cells whose signals can be received by the user terminal in the area of a certain complementary access point. According to the invention, as the user terminal receives signals in its current location in the cellular communications network it at the same time compares received signals with the maintained access point information. If the received signals correspond to the maintained access point information, it can be concluded that a complementary access point is available at that area and the user terminal is able to search for the signal of the complementary access point.

The invention provides a mechanism that alleviates the problem related to the local nature of the WLAN services. Thus the user may easily get information about the WLAN coverage in the neighborhood. The mobile terminal is able to find out about the complementary access network even when the mobile terminal is in the idle state thus reducing power consumption in the terminal. Existing mobile cell signalling can be utilized.

### BRIEF DESCRIPTION OF THE DRAWINGS

In the following the invention will be described in greater detail by means of preferred embodiments with reference to the accompanying drawings, in which

FIG. 1 illustrates a telecommunications system according to the present solution;

FIG. 2 is a flow diagram illustrating a method according to the present solution;

FIG. 3 illustrates a signalling according to the present solution.

### DETAILED DESCRIPTION OF THE INVENTION

The embodiments of the present solution will be described below implemented in a 3G WCDMA (Wideband code division multiple access) mobile communication system, such as the UMTS (Universal mobile telecommunications system). However, the invention is not restricted to these embodiments, but it can be applied in any communication system capable of providing a sufficient coverage. Examples of such mobile systems are IMT-2000, IS-41, CDMA2000, GSM (Global system for mobile communications) or other similar mobile communication systems, such as the PCS (Personal communication system) or the DCS 1800 (Digital cellular system for 1800 MHz). Specifications of communications systems in general and of the IMT-2000 and the UMTS in particular are being developed rapidly. Such a development may require additional changes to be made to the present solution. Therefore, all the words and expressions should be interpreted as broadly as possible and they are only intended to illustrate and not to restrict the invention. What is essential for the present solution is the function itself and not the network element or the device in which the function is implemented.

The present solution utilizes a mechanism that allows a mobile user to find the nearest or otherwise most suitable WLAN access point(s). It is to be noted that in this context the “access point” is a general term, which may refer to an individual WLAN base station (i.e. physical access point) or to a WLAN network or sub-network including several contiguous (physical) access points. Although the invention is especially useful for WLAN access networks, it can be applied in connection with any other radio access network that is complementary to the mobile communication system, such as in a network implementing Bluetooth, infrared, UWB (Ultra wideband) or Flarion technology. Generally, the present solution thus allows the user to find the most suitable network access point. An access point is a site where a connectivity service is available. The users may use any terminals appropriate for communicating with the mobile communication network, such as intelligent phones, portable computers, or PDA (Personal digital assistant) equipment. Although the terminal used to find the access points is typically a multimode terminal capable of accessing the services through the mobile network and the external access network, it may also be different than the terminal for which an access point is needed. For example, a mobile phone may be used to find the most suitable access point for a traditional WLAN terminal. The complementary access network may herein refer to an external access network outside the mobile communications system, wherein the external access network and the mobile communications system are operated and maintained by different operators. It may also refer to an access network that is somehow integrated to the mobile communications system and that is operated and maintained by the same operator as the mobile communications system.

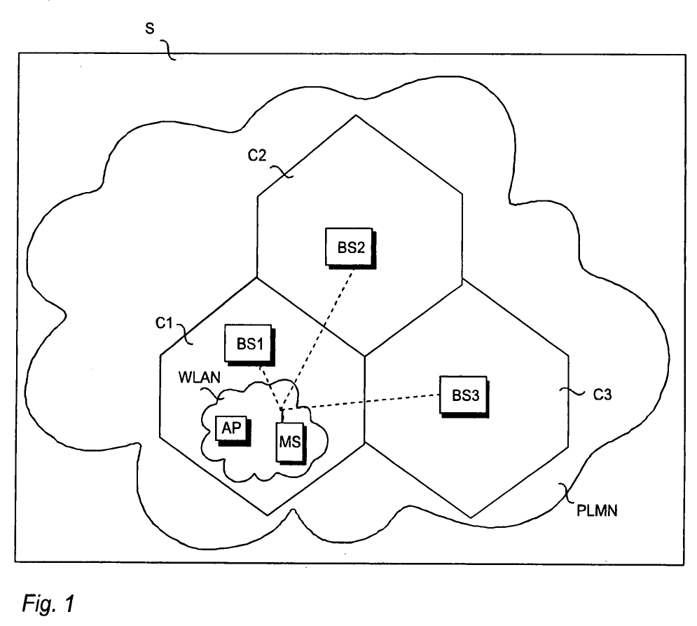

FIG. 1 shows a simplified version of the GSM/UMTS and WLAN access network architecture, which illustrates only the components that are essential to the invention, even though those skilled in the art naturally know that a general mobile communication system and a WLAN system also comprise other functions and structures, which do not have to be described in more detail herein.

Referring to FIG. 1, the telecommunications system S according to an embodiment of the present solution comprises a mobile communications network PLMN and an external access network WLAN. The mobile network PLMN comprises cells C1, C2, C3, the area of each cell being defined by the coverage area of respective base stations BS1, BS2, BS3. In FIG. 1, a situation is shown where a user terminal MS is located in cell C1. The user terminal may be in the active mode or in the idle mode. The idle mode refers to a standby state of the user terminal MS when it is not actively processing a call. The user terminal MS keeps receiving signals from base station BS1 of the current cell C1 and from base stations BS2, BS3 of the other nearby cells C2, C3 as well. The signals of C2 and C3 comprise neighbour cell information, by means of which the user terminal MS is able to find out about the neighbour cells C2, C3, and perform signal measurements e.g. on their signal strength and signal quality at the current location of the user terminal MS. The access network WLAN, which is an external network to the mobile communications network PLMN, comprises the coverage area of the respective access point AP. In FIG. 1, the access network WLAN is overlapping with cell C1 of the mobile network.

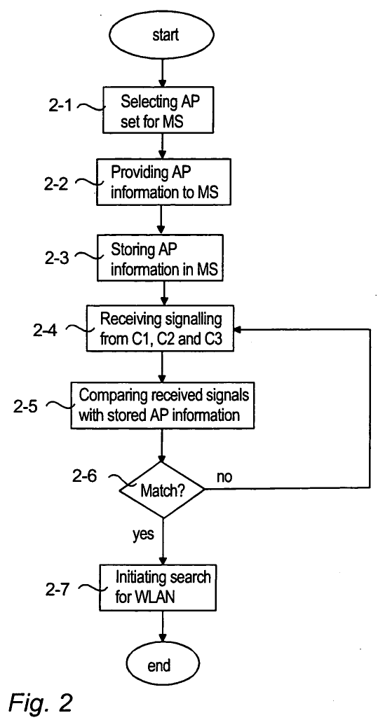

FIG. 2 illustrates the method according to an embodiment of the present solution. According to the embodiment, a set of access points AP is selected 2-1 for the user. The selecting may be based on a common agreement between the user and the network operator. The selected set of access points AP can be user-specific, and it comprises information on at least one access point, through which the user is to able to gain access to WLAN or another network complementary to the PLMN. The user terminal is in advance provided 2-2 with access point information on the selected access points AP and of the mobile cells C1, C2, C3 whose signals are supposed to be measured by the user terminal MS when it is in coverage area WLAN of a certain access point AP included in the selected set of access points AP. The access point information may be provided to the user when the user buys a SIM (Subscriber identity module) card or it may be sent by the operator to the user terminal MS over the network. The access point information may comprise signal strength data, signal quality data, cell identity data, neighbour cell data, etc.

In step 2-3, the user terminal MS stores access point information relating to at least one access point AP and the respective cells C1, C2, C3 from which the user terminal MS would be able to receive signalling if the user terminal MS were on the coverage area of said at least one access point AP or near the coverage area thereof. The access point information may concern the identity of the overlapping and nearby mobile cells, and/or information on which kind of measurements, e.g. signal strength values, can be expected to be measured in the user terminal MS when receiving signals from the mobile cells C1, C2, C3 in the coverage area of a certain WLAN or near the coverage area thereof. The information may also be acquired by the user terminal MS such that the MS is able to store access point information relating to the mobile cells C1, C2, C3 while it is registered to a certain WLAN, and to utilize the information later when visiting the same area again. The storing of the information may herein refer to short-term or long-term storing, depending on which one is more suitable.

In step 2-4, the user terminal MS is located in the mobile cell C1, and the user terminal MS receives and measures the signals received from the current cell C1 and from cells that are neighbour cells C2, C3 to the current cell. The user terminal MS may measure the signals periodically such that the measuring is repeated at predetermined intervals, for example every 30 seconds. The existing signalling and measurements of the prior art mobile communication networks can be utilized.

In step 2-5, the received signals are compared in MS with the access point information stored in step 2-3. For example, the identity of the transmitting cells and/or their signal level at the current location of the MS is examined. If access point information, corresponding in predefined boundaries to the received signals, can be found stored in the user terminal MS, it is concluded in the MS in step 2-6 that at the current location thereof or close thereto there is at least one complementary access network such as a WLAN access network available for the MS, as indicated by the access point information. In this case the process continues to step 2-7. If access point information corresponding to the received signals is not found stored in the user terminal MS, it is concluded in the MS that no external access networks are available for it at the current location thereof. In that case the process returns to step 2-4, where the user terminal MS continues to measure received signals as described above.

In step 2-7, as it has been concluded in the user terminal MS that there is at least one external access network, such as a WLAN access network, available for it, the user terminal MS starts to search for the signal of the respective external access network WLAN based on the stored access point information, and it may begin the registration process to WLAN.

An advantage of the present solution is that it does not require a location system, such as GPS (Global positioning system), to be implemented in the user terminal in order to find out about external access points. Even if there is a location system implemented in the user terminal, the location system does have to be used in order to find an external access point, thus reducing power consumption in the terminal.

According to another embodiment of the present solution, the user terminal is arranged to give an indication to the user when it has found and/or registered to a complementary access network WLAN. The indication may comprise, for example, a beep and/or a message displayed. If the user terminal is near the WLAN network, the indication may comprise an indication of where the user terminal should be moved in order to register.

According to yet another embodiment of the present solution, if more than one access point is found for the user terminal at a certain location, the most suitable access point is selected. The selection of the access is based on a predetermined criteria. Thus a prioritisation list of access points is stored in the MS such that the list comprises only information on the most suitable access points, for example, on the access points of a certain operator. Thus the access point with the highest priority can be chosen. By means of the embodiment the user terminal is able recognize a certain access point, such as the access point at the working place, and perform a handover to said access point always when entering the coverage area of said access point. In that case the priority of the certain complementary access point is defined higher than the priority of the mobile communications network. The priority of access points may be defined by the user and/or by the operator. For example, the mobile operator may own complementary access points and allow the user terminal to use only these access points as complementary access points by prioritizing these access points.

According to yet another embodiment of the present solution the user terminal is able to store access point information on a new access point, or on an access point with changed data, after registering to the access point. In that case the stored access point information comprises information on cells on the basis of signals received and measured by the user terminal while the user terminal is connected to the access point.

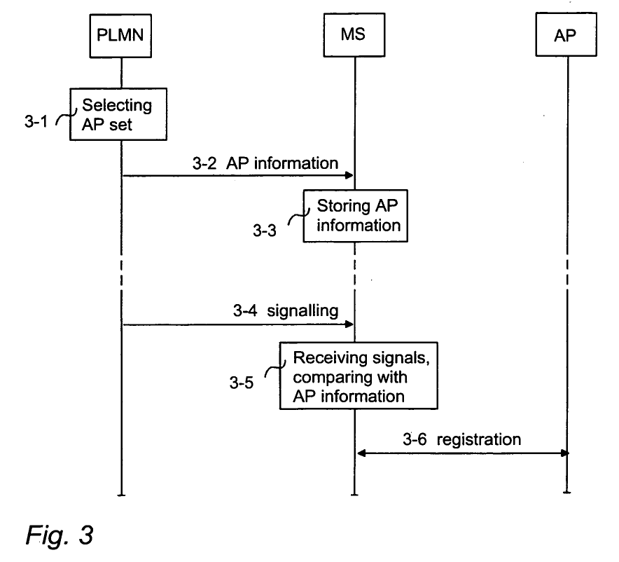

FIG. 3 illustrates the signalling according to an embodiment of the present solution. In step 3-1, a set of complementary access points is selected for the user terminal in the mobile network PLMN. After that, access point information is provided 3-2 to the user terminal MS, said information relating to the access points AP included in said set and the respective cells C1, C2, C3 from which the user terminal MS would be able to receive signalling if the user terminal MS were on the coverage area of said at least one access point AP or near the coverage area thereof. The provision of access point information may be conducted using a point-to-point connection between the PLMN and the user terminal MS, or the access point information may be broadcasted to all user terminals in the PLMN. In step 3-3, the access information is stored in the user terminal.

Base stations BS1, BS2, BS3 of the mobile network PLMN transmit 3-4 signals to the user terminal MS. In step 3-5, the user terminal MS receives the transmitted signals, performs signal measurements on the received signals, and, according to the embodiment, compares the signals to the stored access point information. If the measured signals in given boundaries match with the access point information stored in the user terminal MS, (e.g. current cell identity, neighbour cell identity, signal strength, signal quality) it is concluded in the MS that there is a certain available access point AP at the current location of the user terminal MS. If the comparison between the measured mobile signals and the access point information stored in the MS suggest that there is a certain complementary access network, such as a WLAN network, available, the user terminal MS can start to search for the signal from the WLAN access point AP indicated by the access point information, and begin the registration process between the MS and the AP in step 3-3.

The signalling messages and steps shown in FIGS. 2 and 3 are simplified and aim only at describing the idea of the invention. Other signalling messages may be sent and/or other functions carried out between the messages and/or the steps. The signalling messages serve only as examples and they may contain only some of the information mentioned above. The messages may also include other information, and the titles of the messages may deviate from those given above.

In addition to prior art devices, the system, system nodes or user terminals implementing the operation according to the invention comprise means for storing signal measurement information as described above. The existing network nodes and user terminals comprise processors and memory, which can be used in the functions according to the invention. All the changes needed to implement the invention can be carried out by means of software routines that can be added or updated and/or routines contained in application specific integrated circuits (ASIC) and/or programmable circuits, such as an electrically programmable logic device EPLD or a field programmable gate array FPGA.

It will be obvious to a person skilled in the art that, as technology advances, the inventive concept can be implemented in various ways. The invention and its embodiments are not limited to the examples described above but may vary within the scope of the claims.

1. A method for finding an access point in a communications system comprising a communications network comprising cells, a user terminal that is able to receive signals from one or more cells in the communications network, and one or more access networks complementary to the communications network, each of the access networks having at least one access point, the method comprising the steps of:
selecting a set of access points, the set including at least one access point selected from said one or more access networks;
storing access point information comprising information on an access point included in the set of access points and on respective cells whose signals can be received by the user terminal,
comparing signals received by the user terminal with the stored access point information, and
when the received signals correspond to the stored access point information, initiating a search for a signal of the access point.

2. The method according to claim 1, wherein the step of storing access point information comprises storing the access point information in the user terminal.

3. The method according to claim 1, wherein the comparing step is performed when the user terminal is in an idle mode.

4. The method according to claim 1, wherein the comparing step is performed when the user terminal is in an active mode.

5. The method according to claim 1, wherein the comparing step is repeated regularly at predetermined intervals.

6. The method according to claim 1, further comprising indicating to a user when the search for the signal of the access point is completed.

7. The method according to claim 1, wherein the step of storing access point information comprises storing access point information that is user terminal specific.

8. The method according to claim 1, further comprising selecting a highest priority access point having a highest priority for the user terminal.

9. A communications system comprising:
a communications network comprising cells;
a user terminal capable of receiving signals from one or more cells in the communications network; and
one or more access networks complementary to the communications network, each of the access networks having at least one access point,
wherein the system being configured to select a set of access points, the set including the at least one access point selected from said one or more access networks, and provide access point information to the user terminal, the access point information comprising information on an access point included in the set and on respective cells whose signals can be received by the user terminal, and
wherein the user terminal is configured to compare the signals received from one or more cells with the access point information, and when the received signals correspond to said access point information, initiate a search for a signal of the access point.

10. The communications system according to claim 9, wherein the access point information comprises information on a particular access point on cells whose signals can be received by the user terminal when the user terminal is close to said particular access point.

11. The communications system according to claim 9, wherein the access point information comprises information on a current cell identity.

12. The communications system according to claim 9, wherein the access point information comprises information on neighbour cell identities.

13. The communications system according to claim 9, wherein the access point information comprises information on signal strengths of the respective cells.

14. The communications system according to claim 9, wherein the access point information comprises information on signal quality of the respective cells.

15. The communications system according to claim 9, wherein the access point information comprises information on a cell overlapping with a coverage area of the access point.

16. The communications system according to claim 9, wherein the access point information comprises information on cells close to a cell overlapping a coverage area of the access point.

17. The communications system according to claim 9, wherein the access point information comprises information on cells whose signals can be received by the user terminal when the user terminal is in a coverage area of the access point.

18. The communications system according to claim 9, wherein the access point information comprises information on cells whose signals can be received by the user terminal when the user terminal is close to a coverage area of the access point.

19. The communications system according to claim 9, wherein the access point information is user terminal specific.

20. The communications system according to claim 9, wherein the communications network is a mobile communication network.

21. The communications system according to claim 9, wherein the access network is a wireless local area network (WLAN).

22. A communications network in a communications system comprising a user terminal capable of utilizing services provided by at least one access network that is complementary to the communications network, the communications network comprising cells and being configured to:
select a set of access points, the set including at least one access point selected from one or more access networks complementary to the communications network, and
provide access point information to the user terminal, said access point information comprising information on an access point included in the set and on respective cells whose signals can be received by the user terminal.

23. The communications network according to claim 22, wherein the access point information is provided to the user terminal using a point-to-point connection.

24. The communications network according to claim 22, wherein the access point information is provided to the user terminal by broadcasting the access point information to all user terminals in the communications network.

25. The communications network according to claim 22, wherein the communications network is a mobile communications network.

26. A user terminal capable of receiving signals from one or more cells in a communications system comprising a cellular communications network, the user terminal being capable of utilizing services provided by at least one access network that is complementary to the cellular communications network, the user terminal being configured to:
store access point information comprising information on an access point selected from said at least one access network and on respective cells whose signals can be received by the user terminal,
compare signals received from one or more cells with said access point information, and
when the received signals correspond to said access point information, initiate a search for a signal of the access point.

27. The user terminal according to claim 26, wherein the user terminal is configured to perform the comparison of signals received with the access point information when the user terminal is in an idle mode.

28. The user terminal according to claim 26, wherein the user terminal is configured to perform the comparison of signals received with the access point information when the user terminal is in an active mode.

29. The user terminal according to claim 26, wherein the user terminal is configured to store access point information on a cell overlapping a coverage area of the access point.

30. The user terminal according to claim 26, wherein the user terminal is configured to store access point information on a cell near to a cell overlapping a coverage area of the access point.

31. The user terminal according to claim 26, wherein the user terminal is configured to store access point information on a cell whose signals can be received by the user terminal when the user terminal is in a coverage area of the access point.

32. The user terminal according to claim 26, wherein the user terminal is configured to store access point information on a cell whose signals can be received by the user terminal when the user terminal is close to a coverage area of the access point.

33. The user terminal according to claim 26, wherein the user terminal is configured to perform the comparison of signals received with the access point information when the user terminal at predetermined intervals.

34. The user terminal according to claim 26, wherein the user terminal is configured to indicate to a user when a search for the signal of the access point is completed.

35. The user terminal according to claim 26, wherein the user terminal is configured to store access point information on an access point and on respective cells as a response to the user terminal being connected to said access point.

36. A software product for a communications system comprising a communications network comprising cells, a user terminal capable of receiving signals from one or more cells in the communications network, and one or more access networks complementary to the communications network, each of the access networks having at least one access point, the software product comprising a computer-readable program stored in a program storage means, the program comprising:
a first routine for storing access point information comprising information on at least one access point, selected from said one or more access networks, and on respective cells whose signals can be received by the user terminal,
a second routine for comparing signals received by the user terminal with the stored access point information, and
a third routine for initiating a search for a signal of the access point, when the received signals correspond to the stored access point information.

37. The software product according to claim 36, the software product further comprising a fourth routine for selecting for the user terminal a particular access point having a highest priority.
